(19) United States
(12) Patent Application Publication
(10) Pub. No.: US 2024/0109412 A1
(43) Pub. Date: Apr. 4, 2024

(54) DRIVING ASSISTANCE APPARATUS, DRIVING ASSISTANCE METHOD, AND PROGRAM

(71) Applicant: TOYOTA JIDOSHA KABUSHIKI KAISHA, Toyota-shi (JP)

(72) Inventors: Naoya MATSUNAGA, Nagoya-shi (JP); Takuya Kaminade, Okazaki-shi (JP); Masaki Ikai, Toyota-shi (JP); Ryo Ishii, Toyota-shi (JP); Masashi Oishi, Owariasahi-shi (JP)

(73) Assignee: TOYOTA JIDOSHA KABUSHIKI KAISHA, Toyota-shi (JP)

(21) Appl. No.: 18/461,832

(22) Filed: Sep. 6, 2023

(30) Foreign Application Priority Data
Sep. 30, 2022 (JP) 2022-157838

(51) Int. Cl. B60K 28/02

(52) U.S. Cl. CPC B60K 28/02

(57) ABSTRACT

A driving assistance apparatus includes a parking lot staying determination section which determines whether or not a vehicle is present in a parking lot having a parking row including parking slots and/or parked vehicles located adjacent to each other, an erroneous operation determination section which determines whether or not an occupant has erroneously stepped on an acceleration operation element, and a control section which executes driving power reduction control upon determination that the vehicle is present in the parking lot and that the occupant has performed the erroneous operation. When the erroneous operation determination section determines that the occupant has performed the erroneous operation again before elapse of a predetermined threshold time after execution of the driving power reduction control, the control section executes the driving power reduction control again, irrespective of the result of the determination by the parking lot staying determination section.

### BACKGROUND OF THE INVENTION

### Technical Field

The present disclosure relates to a driving assistance apparatus, a driving assistance method, and a program.

### Description of the Related Art

Conventionally, there has been known an apparatus which performs driving power reduction control for reducing driving power of a vehicle, when a driver of the vehicle performs an erroneous accelerator operation; i.e., erroneously steps on an accelerator pedal (see, for example, Japanese Patent Application Laid-Open (kokai) No. 2021-181787).

If a driver's intentional accelerator operation of stepping on the accelerator pedal by a large amount, for example, for causing the own vehicle to pass a preceding vehicle or to merge into a main lane from an acceleration lane is determined as an erroneous accelerator operation, the driving power reduction control is performed unnecessarily. A conceivable method for avoiding unnecessary performance of the driving power reduction control is, for example, enabling the driving power reduction control under a condition that the vehicle is located in a parking lot.

In general, such an erroneous accelerator operation occurs when the driver intends to perform a brake operation, but the driver steps on the accelerator pedal instead of the brake pedal. In many cases, the driver having performed the erroneous accelerator operation panics in reaction to the failure to generate braking force in the vehicle, and repeats the erroneous accelerator operation. Therefore, in the case where the driver repeats such erroneous accelerator operation in the parking lot, it is desired to appropriately perform the driving power reduction control every time the erroneous accelerator operation is repeated.

One object of the present discloser is to provide a driving assistance apparatus, a driving assistance method, and a program which enable effective performance of driving power reduction control when a driver repeats an erroneous accelerator operation in a parking lot.

A driving assistance apparatus of the present disclosure includes a parking row detection section, a parking lot staying determination section, an erroneous operation determination section, and a control section. The parking row detection section detects a parking slot(s) and/or a parked vehicle(s) around a vehicle on the basis of data of captured images of surroundings of the vehicle and detects a parking row in which a predetermined number or more of the detected parking slot(s) and/or parked vehicle(s) are successively located adjacent to each other in a predetermined direction. The parking lot staying determination section determines whether or not the vehicle is present in a parking lot having the parking row. The erroneous operation determination section detects an operation state of an acceleration operation element operated by an occupant of the vehicle so as to accelerate the vehicle, and determines, on the basis of the operation state, whether or not the occupant has performed an erroneous operation of erroneously stepping on the acceleration operation element. The control section executes driving power reduction control for reducing driving power of the vehicle when the parking lot staying determination section determines that the vehicle is present in the parking lot and the erroneous operation determination section determines that the occupant has performed the erroneous operation. In the case where, before elapse of a predetermined threshold time after execution of the driving power reduction control, the erroneous operation determination section determines that the occupant has performed the erroneous operation again, the control section executes the driving power reduction control again irrespective of the result of the determination by the parking lot staying determination section.

In the driving assistance apparatus having the above-described configuration, when the occupant of the vehicle has performed an erroneous accelerator operation in a parking lot, the control section executes the driving power reduction control. Moreover, in the case where the occupant of the vehicle has performed the erroneous accelerator operation again before elapse of the predetermined threshold time after execution of the driving power reduction control, the control section executes the driving power reduction control again irrespective of the result of the determination as to whether or not the vehicle is present in the parking lot. As a result, it becomes possible to effectively execute the driving power reduction control in the case where the occupant repeats the erroneous accelerator operation in the parking lot. Also, in the case where the number of successive parking slots and/or parked vehicles is equal to or greater than the threshold number, they are determined as a parking row. Therefore, it is possible to effectively prevent erroneous determination, as a parking row, of stop lines and road markings drawn on the surfaces of ordinary roads or other vehicles stopping while waiting for a traffic light to change.

### BRIEF DESCRIPTION OF THE DRAWINGS

FIG. 1 is a diagram schematically showing the overall configuration of a driving assistance apparatus according to an embodiment;

FIG. 2 is a diagram showing separation lines of a parking lot and a parked vehicle as viewed from above;

FIGS. 3(A) to 3(C) are diagrams used for describing determination of a parking row;

FIG. 4 is a timing chart used for describing the specific flow of driving power reduction control;

FIGS. 5(A) and 5(B) are flowcharts used for describing the routine of a parking lot staying determination process and the routine of an erroneous accelerator operation determination process;

FIG. 6 is a flowchart used for describing the routine of a process of driving power reduction control; and

FIGS. 7(A) and 7(B) are diagrams used for describing modifications.

### DESCRIPTION OF THE PREFERRED EMBODIMENT

A driving assistance apparatus, a driving assistance method, and a program according to an embodiment will now be described with reference to the drawings.

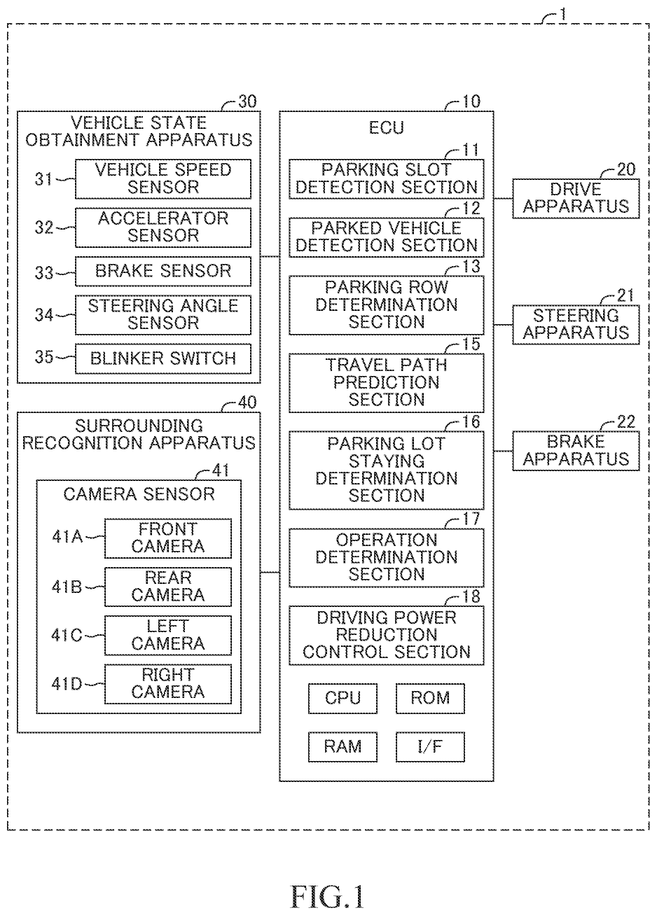

FIG. 1 is a diagram schematically showing the overall configuration of a driving assistance apparatus mounted on a vehicle 1 of the present embodiment. The driving assistance apparatus includes an ECU (electronic control unit) 10. The ECU 10 includes a CPU (central processing unit), a ROM (read only memory), a RAM (random access memory), an interface unit, etc. The CPU is a processor which executes various programs stored in the ROM. The ROM is a non-volatile memory and stores data, etc. which are necessary for the CPU to execute the various programs. The RAM is a volatile memory and provides a working space in which the various programs are developed when executed by the CPU. The interface unit is a communication device for communications with external apparatuses.

The ECU 10 is a central control apparatus which assists a driver in driving; i.e., provides driving assistance. Herein, the expression “driving assistance” is a conceptual expression which encompasses autonomous driving. A drive apparatus 20, a steering apparatus 21, a brake apparatus 22, a vehicle state obtainment apparatus 30, a surrounding recognition apparatus 40, etc. are communicably connected to the ECU 10.

The drive apparatus 20 generates driving power to be transmitted to drive wheels of the vehicle 1. The drive apparatus 20 is, for example, an electric motor or an engine. The steering apparatus 21 applies steering forces to steerable wheels of the vehicle 1. The brake apparatus 22 applies braking forces to the wheels of the vehicle 1.

The vehicle state obtainment apparatus 30 is a group of sensors for obtaining the state of the vehicle 1. Specifically, the vehicle state obtainment apparatus 30 includes a vehicle speed sensor 31, an accelerator sensor 32, a brake sensor 33, a steering angle sensor 34, a blinker switch 35, etc.

The vehicle speed sensor 31 detects the travel speed of the vehicle 1 (vehicle speed V). The accelerator sensor 32 detects the amount of operation of an unillustrated accelerator pedal (acceleration operation element) by a driver. The brake sensor 33 detects the amount of operation of an unillustrated brake pedal by the driver. The steering angle sensor 34 detects the steering angle of an unillustrated steering wheel (or steering shaft). The blinker switch 35 detects operation of an unillustrated blinker lever by the driver. The vehicle state obtainment apparatus 30 transmits the state of the vehicle 1 detected by the sensors 31 to 35 to the ECU 10 at predetermined intervals.

The surrounding recognition apparatus 40 is a group of sensors for obtaining pieces of object information regarding objects around the vehicle 1. Specifically, the surrounding recognition apparatus 40 includes a camera sensor 41. Examples of the pieces of object information include surrounding vehicles, surrounding buildings, intersections, traffic lights, signs, separation lines of parking lots, and white lines, stop lines, etc. on roads. The pieces of object information around the vehicle 1 obtained by the surrounding recognition apparatus 40 are transmitted to the ECU 10.

The camera sensor 41 captures the images of surroundings of the vehicle 1 and processes the obtained image data, thereby obtaining the images of the surroundings of the vehicle 1. The camera sensor 41 is, for example, a stereo camera or a monocular camera, and a digital camera including an image sensor such as a CMOS or a CCD can be used. In the present embodiment, the camera sensor 41 includes a front camera 41A for capturing the image of an area in the forward direction of the vehicle 1, a rear camera 41B for capturing the image of an area in the rearward direction of the vehicle 1, a left camera 41C for capturing the image of an area on the left side of the vehicle 1, and a right camera 41D for capturing the image of an area on the right side of the vehicle 1. In the following description, the plurality of cameras 41A to 41D will be referred to simply as the “camera sensor 41,” and the data of the images captured by the respective cameras 41A to 41D will be referred to collectively as “image data.”

Next, the software configuration of the ECU 10 will be described. The ECU 10 includes, as part of its functional elements, a parking slot detection section 11, a parked vehicle detection section 12, a parking row determination section 13, a travel path prediction section 15, a parking lot staying determination section 16, an erroneous operation determination section 17, and a driving power reduction control section 18. Although these functional elements will be described under the assumption that these functional elements are contained in the ECU 10, which is a single hardware unit. However, some of the functional elements may be provided in another ECU different from the ECU 10. Alternatively, all or some of the functional elements of the ECU 10 may be provided in an information processing apparatus of a facility (for example, a management center or the like) which can communicate with the vehicle 1.

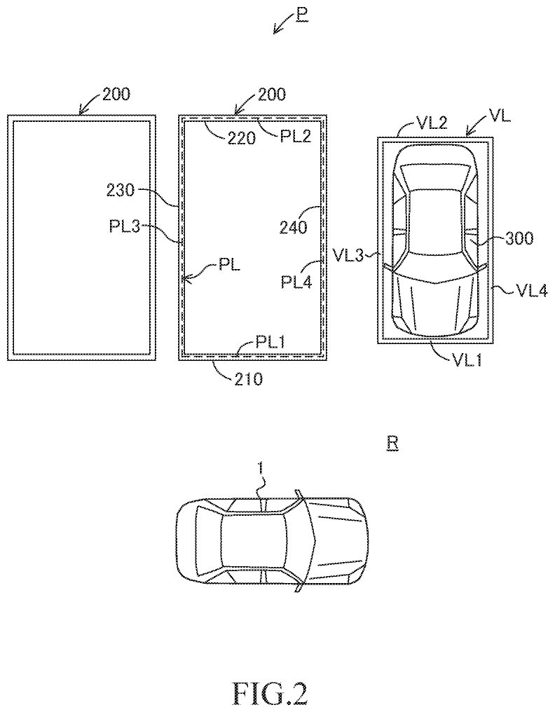

The parking slot detection section 11 detects a parking slot(s) within a parking lot on the basis of the image data (data of the images of the surroundings of the vehicle 1 captured by the camera sensor 41). FIG. 2 is a diagram used for describing an example of separation lines 200 drawn on the paved surface of a parking lot P. In FIG. 2, reference numeral 300 shows a vehicle parked in the parking lot P (hereinafter referred to as the “parked vehicle”), and reference symbol R shows a corridor in which the vehicle 1 having entered the parking lot P travels. The parking slot detection section 11 extracts the separation lines 200 from the image data transmitted from the camera sensor 41 by performing image analyzing processing (e.g., edge extraction, pattern matching, and characteristic point extraction) on the image data, and detects parking slots PL on the basis of the extracted separation lines 200. Herein, the separation lines 200 refer to white lines or the like which are drawn on the paved surface of the parking lot P so as to separate the parking slots PL, each of which allows parking of a single vehicle therein. A determination as to whether or not each extracted separation line 200 is a line for separating the parking slots PL may be made by, for example, comparing the size of an area defined by the extracted separation line 200 and the size (width and depth) of typical parking slots of a general public parking lot.

In FIG. 2, each separation line 200 is a solid line drawn on the paved surface to form an approximately rectangular frame shape. In this case, the parking slot detection section 11 extracts a pair of separation lines 210 and 220 which extend approximately parallel to the extension direction of the corridor R. Specifically, the parking slot detection section 11 extracts, as a front-side boundary line PL1, the separation line 210 on the side toward the corridor R, and extracts, as a back-side boundary line PL2, the separation line 220, which is more far from the corridor R than the separation line 210. Also, the parking slot detection section 11 extracts a pair of separation lines 230 and 240 which approximately perpendicularly intersect with the separation lines 210 and 220. Specifically, the parking slot detection section 11 extracts, as a left-side boundary line PL3, the separation line 230 on the left side as viewed from the corridor R, and extracts, as a right-side boundary line PL4, the separation line 240 on the right side as viewed from the corridor R. The parking slot detection section 11 obtains pieces of information representing the positions of the extracted boundary lines PL1 to PL4 in relation to the vehicle 1 (for examples, the coordinates in an x-y plane coordinate system whose origin coincides with the position of the vehicle 1). Also, the parking slot detection section 11 transmits the obtained pieces of information representing the positions of the extracted boundary lines PL1 to PL4 to the parking row determination section 13 at predetermined intervals.

Notably, each separation line 200 is not limited to the solid line drawn to form a rectangular frame shape shown in FIG. 2, and may be composed of, for example, two parallel straight lines. In the case where each separation line 200 is composed of two parallel straight lines, the parking slot detection section 11 may extract, as the front-side boundary line PL1 and the back-side boundary line PL2, imaginary separation lines which connect opposite ends of the parallel straight lines.

The parked vehicle detection section 12 obtains a vehicle contour line which serves as the boundary between the parked vehicle 300 and the paved surface (hereinafter, referred to as the “parked vehicle contour line”) on the basis of the image data (data of images of the surroundings of the vehicle 1 captured by the camera sensor 41). In FIG. 2, reference symbol VL shows the parked vehicle contour line. Notably, although the parked vehicle contour line VL actually has a complex shape including side view mirrors, etc. in the following description, the parked vehicle contour line VL will be described as a line depicting the smallest rectangular frame which surrounds the outer circumference of the body of the parked vehicle 300.

The parked vehicle detection section 12 first determines whether or not the parked vehicle 300 is contained in the images captured by the camera sensor 41, by performing image analyzing processing (e.g., edge extraction, pattern matching, and characteristic point extraction) on the image data. When the parked vehicle detection section 12 determines that the parked vehicle 300 is contained in the captured images, the parked vehicle detection section 12 determines the line depicting the smallest rectangular frame which surrounds the outer circumference of the body of the parked vehicle 300 (hereinafter, the line will be referred to as the “rectangular frame line”) and extracts the determined rectangular frame line as the parked vehicle contour line VL. The parked vehicle detection section 12 extracts a portion of the determined frame line corresponding to the front end of the parked vehicle 300 as a front-side contour line VL1, a portion of the determined frame line corresponding to the rear end of the parked vehicle 300 as a back-side contour line VL2, a portion of the determined frame line corresponding to the left end of the parked vehicle 300 as a left-side contour line VL3, and a portion of the determined frame line corresponding to the right end of the parked vehicle 300 as a right-side contour line VL4. The parked vehicle detection section 12 obtains pieces of information representing the positions of the extracted contour lines VL1 to VL4 in relation to the vehicle 1 (for examples, the coordinates in the x-y plane coordinate system whose origin coincides with the position of the vehicle 1) and transmits the obtained pieces of position information to the parking row determination section 13 at predetermined intervals.

On the basis of the pieces of information transmitted from the parking slot detection section 12 and representing the positions of the parking slots PL and the piece of information transmitted from the parked vehicle detection section 11B and representing the position of the parked vehicle contour line VL, the parking row determination section 13 determines whether or not the parking slots PL and the parked vehicle contour line VL form a continuous parking row. Notably, in the following description, the lengthwise direction of the parking slots PL and the parked vehicle contour line VL is defined as the “longitudinal direction,” and the direction approximately perpendicular to the lengthwise direction is defined as the “lateral direction.” Also, in the following description, the case where the parking slots PL and the parked vehicle contour line VL are located adjacent to one another in the lateral direction will be described as an example. Since the same processing is performed in the case where these are located adjacent to one another in the longitudinal direction, the processing for such a case will not be described.

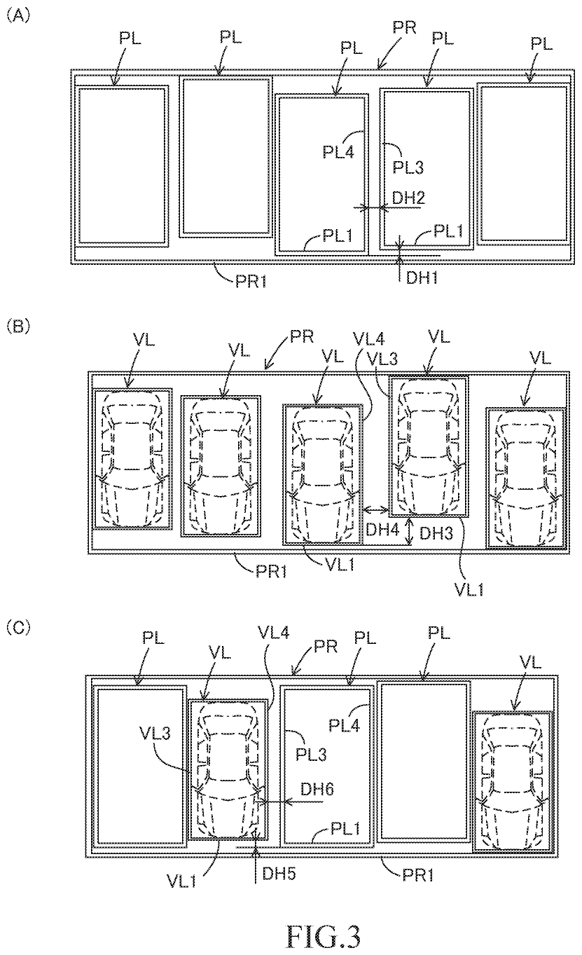

As shown in FIG. 3(A), in the case where parking slots PL located adjacent to one another are detected from the image data, the parking row determination section 13 computes a separation distance DH1 in the longitudinal direction between the front-side boundary lines PL1 of adjacent parking slots PL and determines whether or not a first condition is satisfied. The first condition is that the separation distance DH1 is equal to or shorter than a predetermined first threshold distance. Notably, satisfaction of the first condition may be determined on the basis of the separation distance between the back-side boundary lines PL2. Also, the parking row determination section 13 computes a separation distance DH2 in the lateral direction between the parking slots PL located adjacent to each other (specifically, the separation distance DH2 between the left-side boundary line PL3 of the right-side parking slot PL and the right-side boundary line PL4 of the left-side parking slot PL) and determines whether or not a second condition is satisfied. The second condition is that the separation distance DH2 is equal to or shorter than a predetermined second threshold distance. No particular limitation is imposed on the first and second threshold distances, and the first and second threshold distances may be set on the basis of the typical numerical values of general public parking lots. In the case where both the first and second conditions are satisfied, the parking row determination section 13 determines that these parking slots PL located adjacent to one another form a row which is continuous in the lateral direction.

As shown in FIG. 3(B), in the case where parked vehicle contour lines VL located adjacent to one another are detected from the image data, the parking row determination section 13 computes a separation distance DH3 in the longitudinal direction between the front-side contour lines VL1 of adjacent parked vehicle contour lines VL and determines whether or not a third condition is satisfied. The third condition is that the separation distance DH3 is equal to or shorter than a predetermined third threshold distance. Notably, satisfaction of the third condition may be determined on the basis of the separation distance between the back-side contour lines VL2. Also, the parking row determination section 13 computes a separation distance DH4 in the lateral direction between the parked vehicle contour lines VL (specifically, the separation distance DH4 between the left-side contour line VL3 of the right-side parked vehicle contour line VL and the right-side contour line VL4 of the left-side parked vehicle contour line VL) and determines whether or not a fourth condition is satisfied. The fourth condition is that the separation distance DH4 is equal to or shorter than a predetermined fourth threshold distance. No particular limitation is imposed on the third and fourth threshold distances. However, it is preferred that at least the fourth threshold distance be set to be longer than the above-described second threshold distance. In the case where both the third and fourth conditions are satisfied, the parking row determination section 13 determines that these parked vehicle contour lines VL located adjacent to one another form a row which is continuous in the lateral direction.

As shown in FIG. 3(C), in the case where parking slots PL and parked vehicle contour lines VL are detected from the image data, the parking row determination section 13 computes a separation distance DH5 in the longitudinal direction between a parking slot PL and a parked vehicle contour line VL located adjacent to each other; specifically, the separation distance DH5 between the front-side boundary line PL1 of the parking slot PL and the front-side contour line VL1 of the parked vehicle contour line VL, and determines whether or not a fifth condition is satisfied. The fifth condition is that the separation distance DH5 is equal to or shorter than a predetermined fifth threshold distance. Notably, satisfaction of the fifth condition may be determined on the basis of the separation distance between the back-side boundary line PL2 of the parking slot PL and the back-side contour line VL2 of the parked vehicle contour line VL. Also, the parking row determination section 13 computes a separation distance DH6 in the lateral direction between the parking slot PL and the parked vehicle contour line VL located adjacent to each other; specifically, the separation distance DH6 between the left-side boundary line PL3 (or the right-side boundary line PL4) of the parking slot PL and the right-side contour line VL4 (or the left-side contour line VL3) of the parked vehicle contour line VL, and determines whether or not a sixth condition is satisfied. The sixth condition is that the separation distance DH6 is equal to or shorter than a predetermined sixth threshold distance. No particular limitation is imposed on the fifth and sixth threshold distances. However, it is preferred that at least the sixth threshold distance be set to be longer than the above-described second threshold distance and shorter than the above-described fourth threshold distance. In the case where both the fifth and sixth conditions are satisfied, the parking row determination section 13 determines that the parking slot PL and the parked vehicle contour line VL located adjacent to one another form a row which is continuous in the lateral direction.

In the case where the number of successive parking slots PL, the number of successive parked vehicle contour lines VL, or the number of successive parking slots PL and parked vehicle contour lines VL located in a random order is equal to or greater than a predetermined threshold number (for example, 5), the parking row determination section 13 determines, as a parking row, the smallest rectangular frame PR which surrounds the set of parking slots PL and/or parked vehicle contour lines VL. As described above, in the case where the number of successive parking slots PL, the number of successive parked vehicle contour lines VL, or the number of successive parking slots PL and parked vehicle contour lines VL is equal to or greater than the predetermined threshold number, the set of parking slots PL and/or parked vehicle contour lines VL is determined as a parking row. Thus, it is possible to effectively prevent erroneous determination, as a parking row, of road markings (e.g., stop lines and pedestrian crossings) drawn on the surfaces of ordinary roads or other vehicles stopping around the vehicle 1 because of, for example, waiting for a traffic light to change. The parking row determination section 13 extracts the rectangular frame PR defining the parking row from the image data and obtains pieces of information representing the positions of straight lines PR1 to PR4 forming the extracted rectangular frame PR in relation to the vehicle 1 (for examples, the coordinates in the x-y plane coordinate system whose origin coincides with the position of the vehicle 1). Also, the parking row determination section 13 transmits the pieces of information representing the positions of the obtained straight lines PR1 to PR4 to the parking lot staying determination section 16 at predetermined intervals. In the following description, the straight line PR1 of the rectangular frame PR on the side toward the corridor R will be referred to as the “front-side parking row line.” Also, the rectangular frame PR will be referred to as the “parking row.”

The travel path prediction section 15 computes a predicted travel path of the vehicle 1 on the basis of the travel state of the vehicle 1 obtained by the vehicle state obtainment apparatus 30. Herein, the predicted travel path refers to a locus along which the vehicle 1 is predicted to travel when the current travel state of the vehicle 1 is maintained. The predicted travel path can be computed, for example, on the basis of the vehicle speed V detected by the vehicle speed sensor 31, the steering angle detected by the steering angle sensor 34, etc. The travel path prediction section 15 transmits the computed predicted travel path to the parking lot staying determination section 16 at predetermined intervals.

The parking lot staying determination section 16 determines whether or not the vehicle 1 is present in the parking lot P on the basis of the piece of information transmitted from the parking row determination section 13 and representing the position of the parking row PR in relation to the vehicle 1 and the piece of information transmitted from the travel path prediction section 15 and representing the predicted travel path of the vehicle 1. The parking lot staying determination section 16 first determines whether or not the predicted travel path of the vehicle 1 represented in the plane coordinate system intersects with the front-side parking row line PR1 of the parking row PR. In the case where the parking lot staying determination section 16 determines that the predicted travel path intersects with the front-side parking row line PR1, the parking lot staying determination section 16 computes a predicted reaching time TA necessary for the vehicle 1 at the present position to reach an intersecting position where the predicted travel path intersects with the front-side parking row line PR1. The predicted reaching time TA may be obtained by, for example, dividing the distance D from the present position of the vehicle 1 to the intersecting position along the predicted travel path by the current speed V of the vehicle 1 (TA=D/V). In the case where the predicted reaching time TA is equal to or shorter than a predetermined time (for example, a few seconds), the parking lot staying determination section 16 determines that the vehicle 1 is present in the parking lot P, and turns on a parking lot staying flag FP (FP=1). Meanwhile, in the case where the predicted reaching time TA is longer than the predetermined time, the parking lot staying determination section 16 determines that the vehicle 1 is not present in the parking lot P, and turns off the parking lot staying flag FP (FP=0).

The erroneous operation determination section 17 determines whether or not the driver of the vehicle 1 has performed an erroneous accelerator operation; i.e., has erroneously stepped on the accelerator pedal. Specifically, the erroneous operation determination section 17 determines that an erroneous accelerator operation has been performed and turns on an erroneous operation flag FA (FA=1) in the case where all the following determination conditions are satisfied.

First determination condition: the speed V of the vehicle 1 is lower than a predetermined threshold vehicle speed V_{Min}.

Second determination condition: the amount of accelerator pedal operation (accelerator operation amount) AP is equal to or greater than a predetermined threshold operation amount AP_{Max}.

Third determination condition: the speed of accelerator pedal operation APV is equal to or greater than a predetermined threshold operation speed APV_{Max}.

Fourth determination condition: the brake pedal is not operated.

Fifth determination condition: the blinker lever is not operated.

Meanwhile, in the case where at least one of the first to fifth determination conditions is not satisfied, the erroneous operation determination section 17 determines that the driver has performed no erroneous accelerator operation and turns off the erroneous operation flag FA (FA=0). Notably, any of the first to fifth determination conditions for determining the erroneous accelerator operation may be omitted, or other conditions may be added.

In the case where the parking lot staying determination section 16 determines that the vehicle 1 is present in the parking lot P (FP=1) and the erroneous operation determination section 17 determines that the driver has performed an erroneous accelerator operation (FA=1), the driving power reduction control section 18 executes driving power reduction control which controls the operation of the drive apparatus 20 such that the actual acceleration GA of the vehicle 1 becomes equal to or lower than a predetermined limit acceleration G_{Lim}. As described above, in the case where the driver has performed an erroneous accelerator operation, by executing the driving power reduction control for limiting the actual acceleration GA of the vehicle 1 to the limit acceleration G_{Lim} or lower, it becomes possible to effectively prevent sudden acceleration of the vehicle 1 which is contrary to driver's intentions. Also, since the driving power reduction control section 18 uses, as one of the conditions for executing the driving power reduction control, the determination that the vehicle 1 is present in the parking lot P, it becomes possible to effectively prevent unnecessary execution of the driving power reduction control on ordinary roads, etc. When the accelerator operation amount AP decreases to a predetermined end threshold value APE or less after start of the driving power reduction control, the driving power reduction control section 18 ends the driving power reduction control (cancels the limit acceleration G_{Lim}). Notably, in the case of a vehicle which can perform autonomous driving, such driving power reduction control can be applied when the driving mode is switched from autonomous driving to manual driving (driving by the driver).

Here, the case where the vehicle 1 has passed the front-side parking row line PR1 of the parking row PR as a result of an erroneous accelerator operation of the driver is assumed. When the vehicle 1 has passed the front-side parking row line PR1, the predicted travel path of the vehicle 1 ceases to intersect with the front-side parking row line PR1. Namely, the parking lot staying determination section 16 starts to determine that the vehicle 1 is not present in the parking lot P. However, in a certain period of time after the vehicle 1 has passed the front-side parking row line PR1, the vehicle 1 is highly likely to be present in the parking lot P. Therefore, if the parking lot staying determination section 16 uses, as an essential condition for executing the driving power reduction control, determining that the vehicle 1 is present in the parking lot P, the following problem occurs.

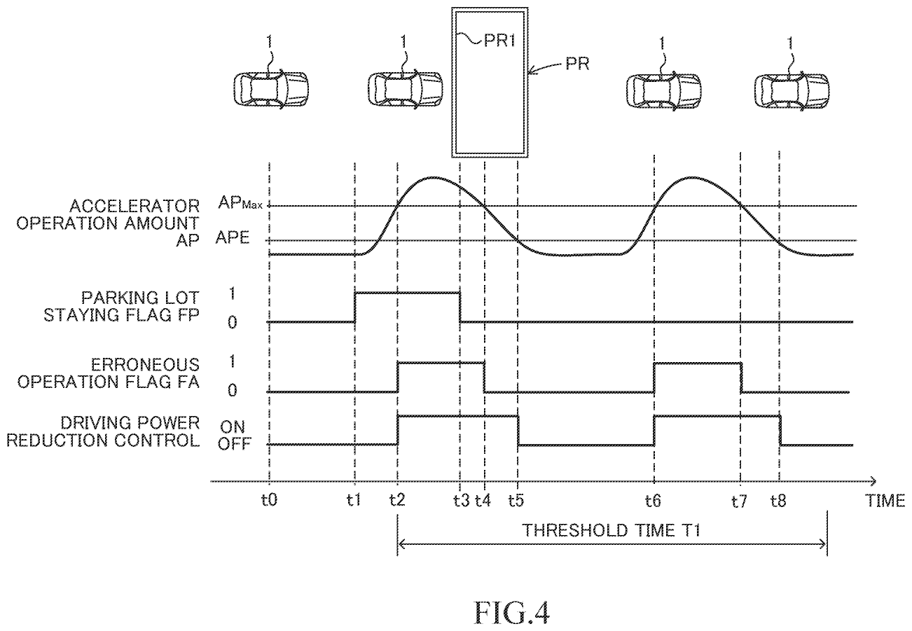

In general, in many cases, the driver who has performed an erroneous accelerator operation panics in reaction to the failure to generate braking force and repeats the erroneous accelerator operation. Therefore, in the case where, after the vehicle 1 has passed the front-side parking row line PR1 as a result of first performance of the erroneous accelerator operation, the driver again performs the erroneous accelerator operation within a predetermined period of time, if the driving power reduction control is stopped on the basis of the result of the determination by the parking lot staying determination section 16, there arises a problem that sudden acceleration of the vehicle 1 cannot be prevented in spite of the fact that, in actuality, the vehicle 1 is present in the parking lot P. In order to solve such a problem, until a predetermined threshold time T1 elapses after execution of the driving power reduction control because of the driver's erroneous accelerator operation, the driving power reduction control section 18 executes the driving power reduction control again when the driver has performed the erroneous accelerator operation again, irrespective of the result of the determination by the parking lot staying determination section 16. The flow of the driving power reduction control will now be described with reference to the timing chart shown in FIG. 4.

As shown in FIG. 4, the vehicle 1 approaches the parking row PR in a period of time t0 to time t1, the parking lot staying flag FP becomes ON (FP=1) at time t1, and the erroneous operation flag FA becomes ON (FA=1) at time t2. In response to this, the driving power reduction control section 18 starts first-time driving power reduction control. When the vehicle 1 passes the front-side parking row line PR1 in a period of time t2 to time t3, the parking lot staying flag FP is switched from ON to OFF (FP=1→0). When the accelerator operation amount AP decreases and becomes smaller than the threshold operation amount AP_{Max} at time t4, the erroneous operation flag FA is switched from ON to OFF (FA=1->0). When the accelerator operation amount AP decreases and becomes equal to the end threshold value APE at time t5, the driving power reduction control section 18 ends the first-time driving power reduction control. When the driver performs the erroneous accelerator operation again at time t6, which is before elapse of the predetermined threshold time T1 from time t2 at which the first-time driving power reduction control was started, the erroneous operation flag FA is switched to ON (FA=0→1). In response to switching of the erroneous operation flag FA to ON (FA=1) at time t6, the driving power reduction control section 18 executes second-time driving power reduction control even when the parking lot staying flag FP is OFF (FP=0).

Namely, the driving power reduction control section 18 is configured such that, until the threshold time T1 elapses after start of the first-time driving power reduction control, the driving power reduction control section 18 performs the second-time driving power reduction control if the driver performs the erroneous accelerator operation, even when the parking lot staying flag FP is OFF. As result, it becomes possible to effectively activate the driving power reduction control in the case where the driver repeats the erroneous accelerator operation, thereby effectively preventing the vehicle 1 from suddenly accelerating in the parking lot P. The second-time driving power reduction control ends when the erroneous operation flag FA is switched to ON (FA=1) at time t7 and the accelerator operation amount AP decreases and becomes equal to the end threshold value APE at time t8. The limit acceleration G_{Lim} used in the second-time driving power reduction control may be the same as that used in the first-time driving power reduction control. Alternatively, the limit acceleration G_{Lim} may be a variable value which varies in accordance with the time which elapses after time t5, at which the first-time driving power reduction control ended. In the case where the limit acceleration G_{Lim} is a variable value, the limit acceleration G_{Lim} may be set such that the shorter the elapsed time, the smaller the acceleration value to which the limit acceleration G_{Lim} is set.

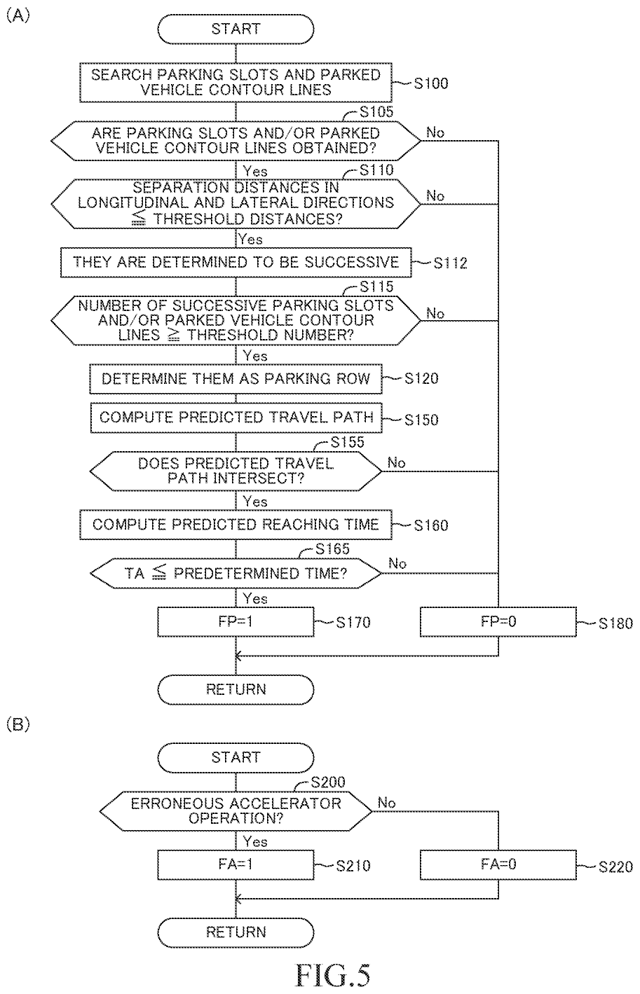

Next, the routines of a parking lot staying determination process and an erroneous accelerator operation determination process, which are performed by the ECU 10, will be described with reference to the flowcharts shown in FIGS. 5(A) and 5(B). When an ignition switch or start button of the vehicle 1 is operated to an ON state, the ECU 10 repeatedly executes the routines of FIGS. 5(A) and 5(B) at predetermined intervals. Notably, the ECU 10 may be configured to execute the routines of FIGS. 5(A) and 5(B) when the speed V of the vehicle 1 is equal to or lower than a predetermined threshold speed.

As shown in FIG. 5(A), in step S100, the ECU 10 searches parking slots PL and parked vehicle contour lines VL around the vehicle 1 on the basis of the image data transmitted from the camera sensor 41. Next, in step S105, the ECU 10 determines whether or not the ECU 10 has succeeded in obtaining at least parking slots PL or parked vehicle contour lines VL from the image data. In the case where the result of the determination is positive (Yes), the ECU 10 proceeds to step S110. Meanwhile, in the case where the result of the determination is negative (No), the ECU 10 proceeds to step S180 so as to set the parking lot staying flag FP to the OFF state (FP=0). Subsequently, the ECU 10 ends the present routine and returns to an unillustrated original (base) routine.

In step S110, the ECU 10 determines whether or not the following condition is satisfied: the separation distances, in the longitudinal direction and the lateral direction, between parking slots PL located adjacent to each other, parked vehicle contour lines VL located adjacent to each other, or a parking slot(s) PL and a parked vehicle contour line(s) VL located adjacent to each other are predetermined threshold distances or less. In the case where the condition is satisfied (Yes), the ECU 10 proceeds to step S112 so as to determine that the parking slots PL located adjacent to each other, the parked vehicle contour lines VL located adjacent to each other, or the parking slot(s) PL and the parked vehicle contour line(s) VL located adjacent to each other form a continuous row. The ECU 10 then proceeds to step S115. Meanwhile, in the case where the ECU 10 determines in step S110 that the condition is not satisfied (No), the ECU 10 proceeds to step S180 so as to set the parking lot staying flag FP to the OFF state (FP=0). Subsequently, the ECU 10 ends the present routine and returns to the original (base) routine.

In step S115, the ECU 10 determines whether or not the following condition is satisfied: the number of successive parking slots PL, the number of successive parked vehicle contour lines VL, or the number of successive parking slot(s) PL and parked vehicle contour line(s) VL is equal to or greater than a threshold number. In the case where the condition is satisfied (Yes), the ECU 10 proceeds to step S120 so as to determine them as a parking row and obtain a piece of information representing the position of the parking row PR. Subsequently, the ECU 10 proceeds to step S150. Meanwhile, in the case where the ECU 10 determines in step S115 that the condition is not satisfied (No), the ECU 10 proceeds to step S180 so as to set the parking lot staying flag FP to the OFF state (FP=0). Subsequently, the ECU 10 ends the present routine and returns to the original (base) routine.

In step S150, the ECU 10 computes the predicted travel path TP of the vehicle 1. Subsequently, in step S155, the ECU 10 determines whether or not the calculated predicted travel path TP intersects with the front-side parking row line PR1 of the parking row PR. In the case where the predicted travel path TP intersects with the front-side parking row line PR1 (Yes), the ECU 10 proceeds to step S160. Meanwhile, in the case where the predicted travel path TP does not intersect with the front-side parking row line PR1 (No), the ECU 10 proceeds to step S180 so as to set the parking lot staying flag FP to the OFF state (FP=0). Subsequently, the ECU 10 ends the present routine and returns to the original (base) routine.

In step S160, the ECU 10 computes the predicted reaching time TA; i.e., the time necessary for the vehicle 1 at the present position to reach the intersecting position where the predicted travel path intersects with the front-side parking row line PR1. Next, in step S165, the ECU 10 determines whether or not the predicted reaching time TA is equal to or shorter than the predetermined time. In the case where the predicted reaching time TA is equal to or shorter than the predetermined time (Yes), the ECU 10 proceeds to step S170. Meanwhile, in the case where the predicted reaching time TA is not equal to or shorter than the predetermined time (No), the ECU 10 proceeds to step S180 so as to set the parking lot staying flag FP to the OFF state (FP=0). Subsequently, the ECU 10 ends the present routine and returns to the original (base) routine. In step S170, the ECU 10 determines that the vehicle 1 is present in the parking lot P; namely, sets the parking lot staying flag FP to the ON state (FP=1). Subsequently, the ECU 10 ends the present routine and returns to the original (base) routine.

As shown in FIG. 5(B), in step S200, the ECU 10 determines whether or not the driver has performed an erroneous accelerator operation. In the case where all the first to fifth determination conditions described above are satisfied (Yes), the ECU 10 determines that the driver has performed an erroneous accelerator operation and proceeds to step S210. Meanwhile, in the case where any of the first to fifth determination conditions described above is not satisfied (No), the ECU 10 determines that the driver has not performed any erroneous accelerator operation and proceeds to step S220. In step S210, the ECU 10 turns on the erroneous operation flag FA (FA=1). Subsequently, the ECU 10 ends the present routine and returns to the original (base) routine. In step S220, the ECU 10 turns off the erroneous operation flag FA (FA=0). Subsequently, the ECU 10 ends the present routine and returns to the original (base) routine.

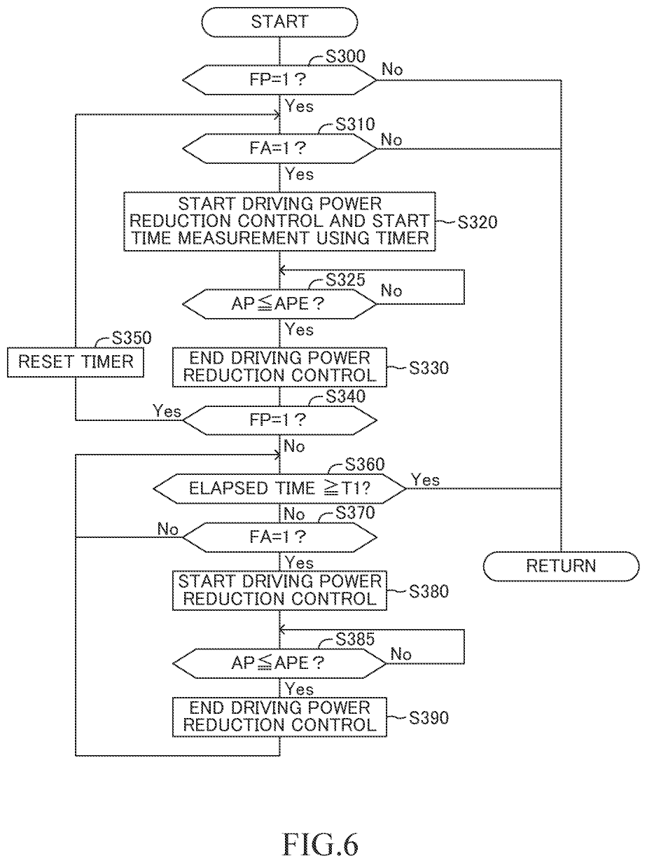

Next, the routine of a driving power reduction control process performed by the ECU 10 will be described with reference to the flowchart shown in FIG. 6. The present routine is executed in parallel with the routines of the parking lot staying determination process and the erroneous accelerator operation determination process shown in FIGS. 5(A) and 5(B).

In step S300, the ECU 10 determines whether or not the parking lot staying flag FP is ON. In the case where the parking lot staying flag FP is ON (Yes), the ECU 10 proceeds to step S310. Meanwhile, in the case where the parking lot staying flag FP is not ON (No); namely, the parking lot staying flag FP is OFF, the ECU 10 ends the present routine and returns to the original (base) routine.

In step S310, the ECU 10 determines whether or not the erroneous operation flag FA is ON. In the case where the erroneous operation flag FA is ON (Yes), the ECU 10 proceeds to step S320. Meanwhile, in the case where the erroneous operation flag FA is not ON (No); namely, the erroneous operation flag FA is OFF, the ECU 10 ends the present routine and returns to the original (base) routine.

In step S320, the ECU 10 starts the driving power reduction control and starts time measurement using a timer. Subsequently, in step S325, the ECU 10 determines whether or not the accelerator operation amount AP has decreased to the end threshold value APE or less. In the case where the accelerator operation amount AP has not yet decreased to the end threshold value APE or less (No), the ECU 10 repeats the determination of step S325. Meanwhile, in the case where the accelerator operation amount AP has decreased to the end threshold value APE or less (Yes), the ECU 10 proceeds to step S330 so as to end the driving power reduction control and then proceeds to step S340.

In some cases, a new parking slot PR is detected ahead of the vehicle 1 after the vehicle 1 has passed the parking slot PR as a result of the driver's erroneous accelerator operation. In step S340, the ECU 10 determines whether or not the parking lot staying flag FP is ON. In the case where the parking lot staying flag FP is ON (Yes), the ECU 10 proceeds to step S350 so as to reset the elapsed time measured by the timer and then returns to step S310. Meanwhile, in the case where the parking lot staying flag FP is not ON (No); namely, the parking lot staying flag FP is OFF, the ECU 10 proceeds to step S360.

In step S360, the ECU 10 determines whether or not the elapsed time whose measurement by the timer was started in step S320 has reached the threshold time T1. In the case where the elapsed time has reached the threshold time T1 (Yes), the ECU 10 ends the present routine and returns to the original (base) routine. Meanwhile, in the case where the elapsed time has not yet reached the threshold time T1 (No), the ECU 10 proceeds to step S370.

In step S370, the ECU 10 determines whether or not the erroneous operation flag FA is ON. In the case where the erroneous operation flag FA is ON (Yes), the ECU 10 proceeds to step S380. Meanwhile, in the case where the erroneous operation flag FA is not ON (No); namely, the erroneous operation flag FA is OFF, the ECU 10 returns to step S360.

In step S380, the ECU 10 starts the driving power reduction control. Subsequently, in step S385, the ECU 10 determines whether or not the accelerator operation amount AP has decreased to the end threshold value APE or less. In the case where the accelerator operation amount AP has not yet decreased to the end threshold value APE or less (No), the ECU 10 repeats the determination of step S385. Meanwhile, in the case where the accelerator operation amount AP has decreased to the end threshold value APE or less (Yes), the ECU 10 proceeds to step S390 so as to end the driving power reduction control and then returns to step S360.

Although the driving assistance apparatus, the driving assistance method, and the program according to the present embodiment have been described above, the present disclosure is not limited to the above-described embodiment and various modifications may be possible so long as the modifications do not depart from the purpose of the present invention.

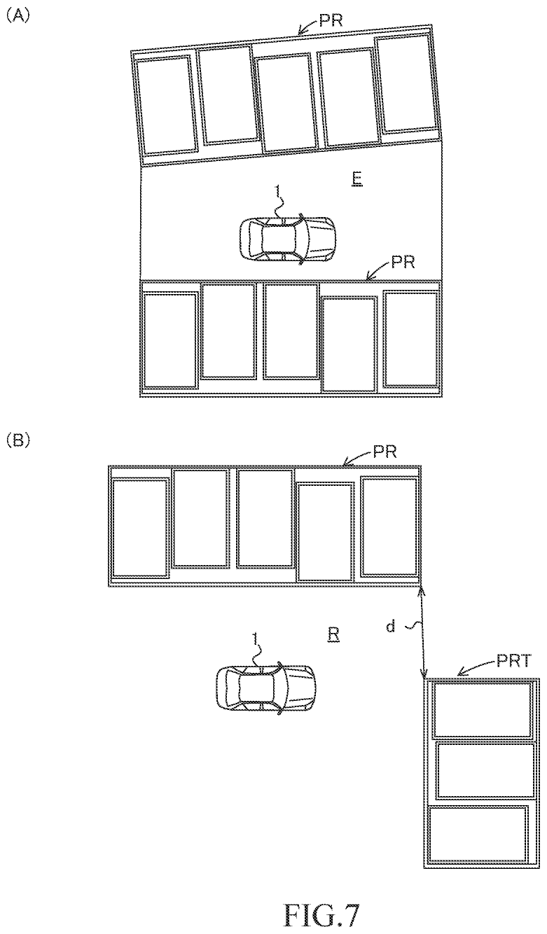

For example, in the case where the parking row determination section 13 detects parking rows PR which are located on opposite lateral sides of the vehicle 1 as shown in FIG. 7(A), the parking lot staying determination section 16 may determine that the vehicle 1 is present in the parking lot P when the vehicle 1 is located in an area E between these parking rows PR. Also, in the case where the parking row determination section 13 detects a provisional parking row PRT which is located near the parking row PR and in which the number of successive parking slots PL or parked vehicles VL is smaller than the threshold number as shown in FIG. 7(B), the parking row determination section 13 may determine the provisional parking row PRT as the parking row PR when the distance d between the parking row PR and the provisional parking row PRT is equal to or shorter than a predetermined distance.

What is claimed is:

1. A driving assistance apparatus comprising:
a parking row detection section which detects a parking slot(s) and/or a parked vehicle(s) around a vehicle on the basis of data of captured images of surroundings of the vehicle and detects a parking row in which a predetermined number or more of the detected parking slot(s) and/or parked vehicle(s) are successively located adjacent to each other in a predetermined direction;
a parking lot staying determination section which determines whether or not the vehicle is present in a parking lot having the parking row;
an erroneous operation determination section which detects an operation state of an acceleration operation element operated by an occupant of the vehicle so as to accelerate the vehicle and which determines, on the basis of the operation state, whether or not the occupant has performed an erroneous operation of erroneously stepping on the acceleration operation element; and
a control section which executes driving power reduction control for reducing driving power of the vehicle when the parking lot staying determination section determines that the vehicle is present in the parking lot and the erroneous operation determination section determines that the occupant has performed the erroneous operation, wherein
in the case where, before elapse of a predetermined threshold time after execution of the driving power reduction control, the erroneous operation determination section determines that the occupant has performed the erroneous operation again, the control section executes the driving power reduction control again irrespective of the result of the determination by the parking lot staying determination section.

2. A driving assistance apparatus according to claim 1, wherein the parking lot staying determination section predicts a travel path of the vehicle on the basis of a travel state of the vehicle and determines that the vehicle is present in the parking lot when the predicted travel path intersect with the parking row.

3. A driving assistance method comprising the steps of:
detecting a parking slot(s) and/or a parked vehicle(s) around a vehicle on the basis of data of captured images of surroundings of the vehicle and detecting a parking row in which a predetermined number or more of the detected parking slot(s) and/or parked vehicle(s) are successively located adjacent to each other in a predetermined direction;
determining whether or not the vehicle is present in a parking lot having the parking row;
detecting an operation state of an acceleration operation element operated by an occupant of the vehicle so as to accelerate the vehicle and determining, on the basis of the operation state, whether or not the occupant has performed an erroneous operation of erroneously stepping on the acceleration operation element;
executing driving power reduction control for reducing driving power of the vehicle upon determination that the vehicle is present in the parking lot and determination that the occupant has performed the erroneous operation; and
executing the driving power reduction control again, irrespective of the result of the determination as to whether or not the vehicle is present in the parking lot, in the case where, before elapse of a predetermined threshold time after execution of the driving power reduction control, it is determined that the occupant has performed the erroneous operation again.

4. A program for causing a computer of a driving assistance apparatus to perform a process of;
detecting a parking slot(s) and/or a parked vehicle(s) around a vehicle on the basis of data of captured images of surroundings of the vehicle and detecting a parking row in which a predetermined number or more of the detected parking slot(s) and/or parked vehicle(s) are successively located adjacent to each other in a predetermined direction;
determining whether or not the vehicle is present in a parking lot having the parking row;
detecting an operation state of an acceleration operation element operated by an occupant of the vehicle so as to accelerate the vehicle and determining, on the basis of the operation state, whether or not the occupant has performed an erroneous operation of erroneously stepping on the acceleration operation element;
executing driving power reduction control for reducing driving power of the vehicle upon determination that the vehicle is present in the parking lot and determination that the occupant has performed the erroneous operation; and
executing the driving power reduction control again, irrespective of the result of the determination as to whether or not the vehicle is present in the parking lot, in the case where, before elapse of a predetermined threshold time after execution of the driving power reduction control, it is determined that the occupant has performed the erroneous operation again.
